(19) United States
(12) Patent Application Publication
(10) Pub. No.: US 2012/0261209 A1
(43) Pub. Date: Oct. 18, 2012

(54) TORQUE SENSOR AND POWER STEERING SYSTEM

(75) Inventor: Kohtaro SHIINO, Isehara-shi (JP)

(73) Assignee: HITACHI AUTOMOTIVE SYSTEMS STEERING, LTD.

(21) Appl. No.: 13/444,209

(22) Filed: Apr. 11, 2012

(30) Foreign Application Priority Data
Apr. 15, 2011 (JP) 2011-091153

(51) Int. Cl. B62D 6/10; B62D 5/04; G06F 19/00

(52) U.S. Cl. 180/446; 702/41

(57) ABSTRACT

First and second shafts are connected with each other through a torsion bar and arranged to rotate relative to each other within a relative rotational angle range A. A s torque sensor includes first and second resolvers for sensing the angular potions of the first and second shafts, respectively. The first resolver produces a periodical first resolver output signal so that the number X1 of cycles per revolution of the first shaft is smaller than 360/A (X1<360/A). The second resolver produces a periodical second resolver output signal so that the number X2 of cycles per revolution of the second shaft is smaller than 360/A (X2<360/A).

### BACKGROUND OF THE INVENTION

The present invention relates to a torque sensor and a power steering apparatus or system.

A Japanese patent document, JP 2010-286310A discloses a vehicular power steering system including a torque sensor for sensing a steering torque caused by a driver's steering operation of turning a steering wheel, and a controller to impart a steering assist force to the steering system or steering linkage in accordance with the sensed steering torque. The torque sensor includes a torsion bar connecting first and second shafts, and first and second resolvers provided, respectively, on the first and second shafts and arranged to sense the relative rotation between the first and second shafts and to calculate the torque transmitted through the torsion bar, from the quantity of the relative rotation between the first and second shafts or the quantity of torsion of the torsion bar.

### SUMMARY OF THE INVENTION

However, the system of the above-mentioned document is still insufficient in setting of characteristics of the resolvers for the use in a torque sensor.

It is an object of the present invention to provide an apparatus such as a torque sensor and a power steering apparatus, including resolvers having adequate or optimum characteristics.

According to one aspect of the present invention, an apparatus such as a torque sensor or a power steering apparatus comprises: a rotation shaft including a first shaft and a second shaft which are connected with each other through a torsion bar and which are arranged to rotate relative to each other within a relative rotational angle range in which a relative angle between the first shaft and the second shaft due to torsion of the torsion bar is limited to a maximum angle A; a first resolver including a first resolver rotor arranged to rotate with the first shaft and a first resolver stator arranged to produce a first sine wave signal and a first cosine wave signal at a number of cycles per revolution X1 within a range in which the number of io cycles per revolution of the first resolver rotor is smaller than 360/A (X1<360/A); a second resolver including a second resolver rotor arranged to rotate with the second shaft and a second resolver stator arranged to produce a second sine wave signal and a second cosine wave signal at a number of cycles per revolution X2 within a range in which the number of cycles per revolution of the second resolver rotor is smaller than 360/A (X2<360/A); and a control unit which includes a microcomputer and which includes a calculation section to calculate a first rotational angle representing a rotational angle of the first shaft in accordance with the first sine wave signal and the first cosine wave signal, to calculate a second rotational angle representing a rotational angle of the second shaft in accordance with the second sine wave signal and the second cosine wave signal, and to calculate a torque produced between the first and second shafts, in accordance with a phase difference between the first rotational angle and the second rotational angle.

According to another aspect, an apparatus (such as a torque sensor or a power steering apparatus) comprises: a rotation shaft including a first shaft connected with a steering wheel and a second shaft which is connected with a steerable wheel, and which is further connected with the first shaft through a torsion bar; a torque sensing device provided in the rotation shaft; an electric motor to provide a steering assist force to the steerable wheel; a controller which includes a microcomputer having a bit length B and which includes a calculation section to calculate a torque produced between the first and second shafts, in io accordance with a sensor signal produced by the torque sensing device, a switching circuit to control power supply to the electric motor in accordance with the torque, and a low-pass filter provided between the torque sensing element and the switching circuit, to remove components with frequencies higher than a predetermined cutoff frequency F Hz; wherein the torque sensing device includes a first resolver including a first resolver rotor rotating with the first shaft, and a first resolver stator to produce a first sine wave signal and a first cosine wave signal at a number X1 of cycles per revolution of the first resolver rotor within a range in which the number X1 of cycles per revolution of the first resolver rotor is greater than or equal to 360×F/2^{B} (X1≧360×F/2^{B}), and a second resolver including a second resolver rotor rotating with the second shaft, and a second resolver stator to produce a second sine wave signal and a second cosine wave signal at a number X2 of cycles per revolution of the second resolver rotor within a range in which the number X2 of cycles per revolution of the second resolver rotor is greater than or equal to 360×F/2^{B} (X2≧360×F/2^{B}); and wherein the calculation section is configured to calculate a first rotational angle representing a rotational angle of the first shaft in accordance with the first sine wave signal and the first cosine wave signal, to calculate a second rotational angle representing a rotational angle of the second shaft in accordance with the second sine wave signal and the second cosine wave signal, and to calculate the torque in accordance with a phase difference between the first rotational angle and the second rotational angle.

### BRIEF DESCRIPTION OF THE DRAWINGS

FIG. 1 is a view schematically showing a power steering apparatus according to an embodiment of the present invention.

FIG. 2 is a sectional view showing a torque sensor according to the embodiment.

FIG. 3 is a plan view showing a resolver rotor in first or second resolver shown in FIG. 2.

FIG. 4 is a functional block diagram showing functions of a torque sensing ECU shown in FIG. 2.

FIG. 5A is a graph showing a relationship between the rotational angular position of an input side resolver rotor and an input side electrical angle in an illustrated example of the embodiment. FIG. 5B is a graph showing a relationship between the rotational angular position of an output side resolver rotor and an output side electrical angle in the illustrated example of the embodiment.

FIG. 6 is a view for illustrating a relation between the input side and output side electrical angles during steering operation.

FIG. 7 is a table illustrating the relation between input side and output side electrical angles θ1 and θ2 and the steering direction.

FIG. 8 is a flowchart showing a process of calculating a steering torque in a torque calculating section shown in FIG. 4.

FIG. 9A is a graph showing a relationship between the rotational angular position of the input side resolver rotor and the input side electrical angle in a variation example of the embodiment. FIG. 9B is a graph showing a relationship between the rotational angular position of the output side resolver rotor and the output side electrical angle in the variation example.

### DETAILED DESCRIPTION OF THE INVENTION

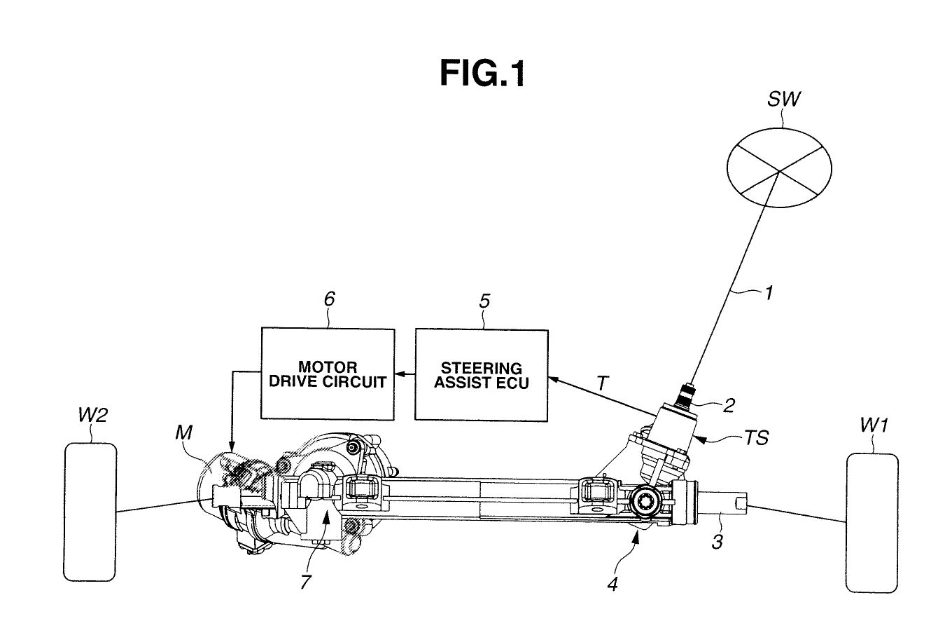

FIG. 1 shows an apparatus according to one embodiment of the present invention. In this embodiment, the apparatus is a power steering system or apparatus. The power steering system of the example shown in FIG. 1 includes a pinion shaft 2 receiving rotation from a steering wheel SW through a steering shaft 1, and a rack shaft 3 arranged to move linearly in response to rotation of pinion shaft 2 and to steer left and right steerable wheels W1 and W2 connected with the left and right ends of rack shaft 3, respectively. The pinion shaft 2 and rack shaft 3 form a first steering mechanism 4, which, in this example, is a first rack and pinion mechanism 4, for manual steering operation.

The rack shaft 3 is connected with a motor M controlled by a steering assist ECU 5 and a motor drive circuit 6 serving as a motor drive section, through a second steering mechanism 7, which, in this example, is a second rack and pinion mechanism 7, for steering assist. Steering assist ECU 5 receives a signal of a steering torque T supplied from a torque sensor TS provided in pinion shaft 2, sends a motor drive command signal to motor drive circuit 6 in accordance with the steering torque T, and thereby supplies electric power to motor M through motor drive circuit 6. Thus, under the control of steering assist ECU 5, the motor M imparts rotational driving force, as a steering assist force, to the rack shaft 3, through the second rack and pinion mechanism 7.

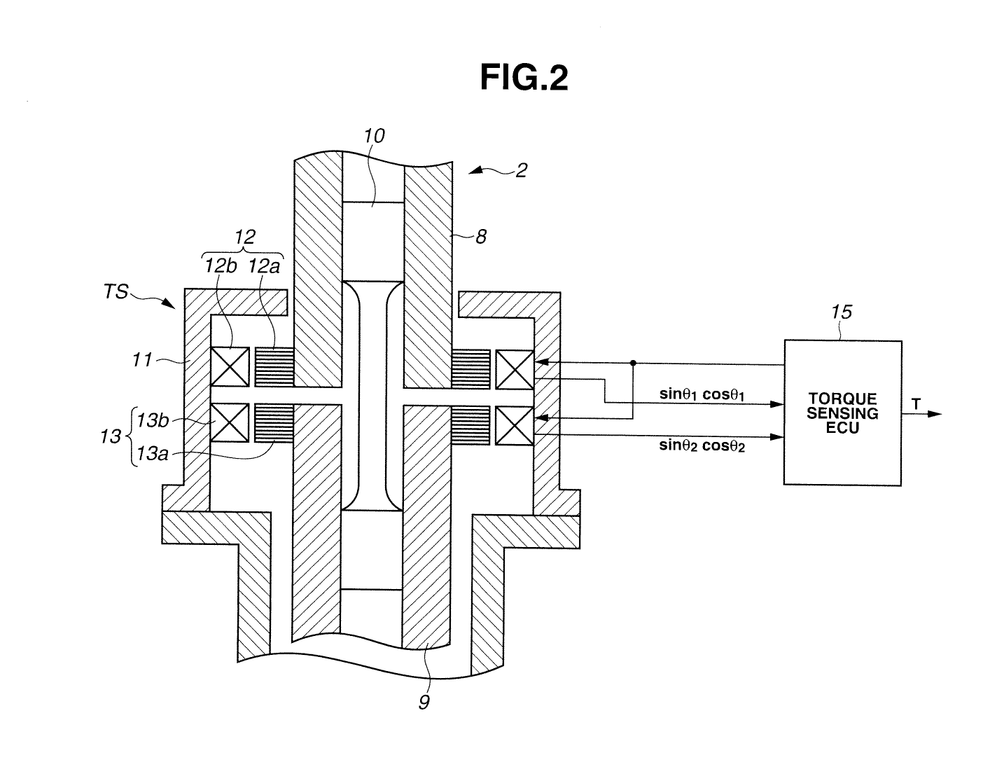

FIG. 2 schematically shows the torque sensor TS in section. As shown in FIG. 2, the pinion shaft 2 is made up of an input shaft 8 as a first shaft receiving rotation of steering wheel SW, and an output shaft 9 as a second shaft engaging with rack shaft 3. The input and output shafts 8 and 9 are hollow shafts aligned end to end. Input and output shafts 8 and 9 are coupled coaxially so as to form a single shaft, through a torsion bar 10 received in the inside cavities of the hollow input and output shafts 8 and 9. Torsion bar 10 includes a first end engaged with the inside circumferential surface of input shaft 8 by serrations so as to prevent relative rotation, and a second end engaged with the inside circumferential surface of output shaft 9 by serrations so as to prevent relative rotation. Input and output shafts 8 and 9 are rotatable relative to each other by torsion or twisting of the torsion bar 10.

The relative rotational angle of input shaft 8 relative to output shaft 9 is limited within a predetermined relative rotational angle range by a stopper mechanism (not shown). Input shaft 8 is arranged to lie at a middle position in the relative rotational angle range in a free or neutral state of torsion bar 10 in which the torsion quantity of torsion bar 10 is zero or torsion bar 10 is not twisted. When the relative rotational angle range of input shaft 8 relative to output shaft 9 is A° and the relative rotational angular position of input shaft 8 relative to output shaft 9 is zero in the free state of torsion bar 10, then the input shaft 8 is rotatable relative to output shaft 9 in the range from −A°/2 to A°/2. In this example according to the embodiment, the relative rotational angle range is 12°, and input shaft 8 is capable of rotating from the position in the free state of torsion bar 10, in a range of 6° in each of the leftward and rightward directions, relative to output shaft 9.

A housing 11 surrounds pinion shaft 2. Between the housing 11 and input shaft 8, there is provided an input side resolver 12 (or a first resolver) to sense the rotational position or angular position of input shaft 8. Between housing 11 and output shaft 9, there is provided an output side resolver 13 (or a second resolver) to sense the rotational position or angular position of output shaft 9. The housing 11 is fixed to the vehicle body of the vehicle.

The resolvers 12 and 13 are of a known variable reluctance type (VR resolver) including a stator provided with a coil and a rotor provided with no coil. The input side resolver 12 includes an annular input side resolver rotor 12a (or a first resolver rotor) fit over (the outside circumferential surface of) input shaft 8 integrally, and an annular input side resolver stator 12b (or a first resolver stator) which surrounds the input side resolver rotor 12a with a predetermined radial gap or clearance, and which is fixed to housing 11. The output side resolver 13 includes an annular output side resolver rotor 13a (or a second resolver rotor) fit over (the outside circumferential surface of) output shaft 9 integrally, and an annular output side resolver stator 13b (or a second resolver stator) which surrounds the output side resolver rotor 13a with a predetermined radial gap or clearance, and which is fixed to housing 11.

As is known in the art, the input side resolver stator 12b outputs, as a first resolver output signal, an input side io sine wave signal sinθ1 and an input side cosine wave signal cosOl so that there are n1 cycles for each revolution (360°) of input side resolver rotor 12a. Output side resolver stator 13b outputs, as a second resolver output signal, an output side sine wave signal sinθ2 and an input side cosine wave signal cosθ2 so that there are n2 cycles for each revolution) (360°) of output side resolver rotor 13a. In other words, the input side resolver 12 is so arranged that the shaft angle multiplier (or multiplication factor of angle) is equal to n1, and the output side resolver 13 is so arranged that the shaft angle multiplier (or multiplication factor of angle) is equal to n2.

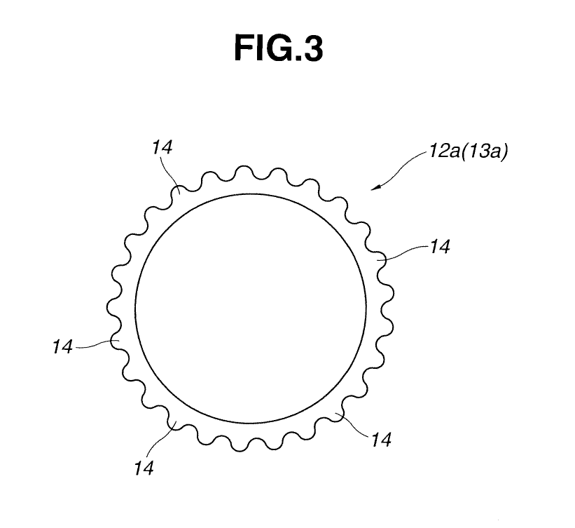

FIG. 3 shows the resolver rotor 12a (or resolver rotor 13a) in plan view. As shown in FIG. 3, each of resolver rotors 12a and 13a includes projections 14 formed at regular intervals in the outer circumferential or cylindrical surface of the rotor 12a or 13a. The number of projections 14 corresponds to (or equals) the shaft angle multiplier n1 or n2 of the resolver 12 or 13. The projections 14 are formed so as to vary a gap permeance between the rotor 12a or 13a and the stator 12b or 13b in the form of a sine or sinusoidal wave in accordance with the rotational position of the rotor 12a or 13a. In the illustrated example of this embodiment, the resolver rotors 12a and 13a are identical in shape, and the shaft angle multiplier n1 of input side resolver 12 and the shaft angle multiplier n2 of output side resolver 13 are equal to each other.

As shown in FIG. 2, a torque sensing ECU 15 is connected with resolvers 12 and 13 and arranged to receive the sine wave signals sinθ1 and sinθ2 and the cosine wave signals cosθ1 and cosθ2. In this example, ECU 15 includes a microcomputer having a bit length of 12 bits. With the microcomputer, ECU 15 performs calculating operations as mentioned later. ECU 15 calculates a steering torque T acting on the torsion bar 10, from the sine wave signals sinθ1 and sinθ2 and cosine wave signals cosθ1 and cosθ2, and delivers the steering torque T as a torque sensor signal.

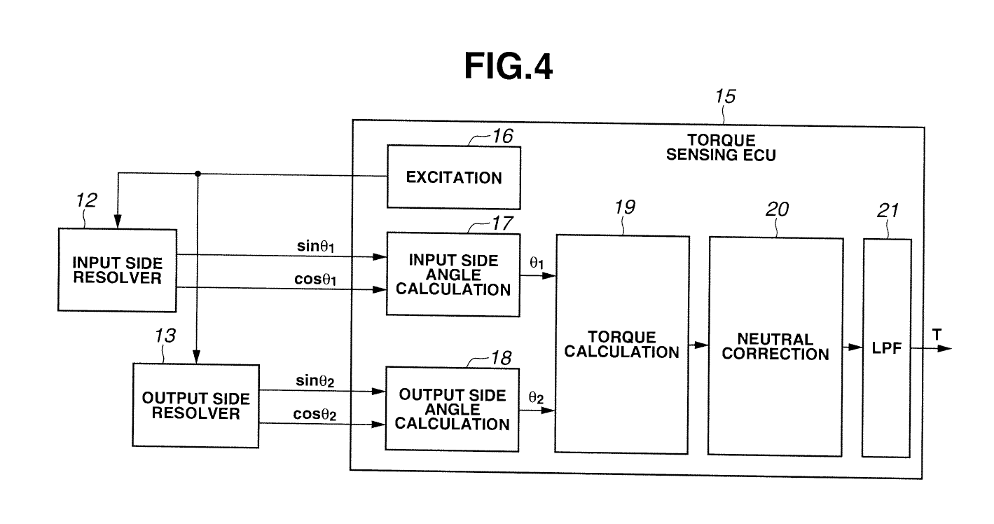

FIG. 4 shows functions of the torque sensing ECU 15 in the form of a block diagram. As shown in FIG. 4, the torque sensing ECU 15 includes an exciting section 16, an input side angle calculating section 17, an output side angle calculating section 18, a torque calculating section 19, a neutral correcting section 20, and a low-pass filter 21. The exciting section 16 supplies exciting voltages to resolvers 12 and 13. The input side angle calculating section 17 calculates an input side electrical angle θ1 (first electrical angle) representing the rotational (angular) position of input shaft 8, in accordance with the input side sine wave signal sinθ1 and input side cosine wave signal cosθ1. The output side angle calculating section 18 calculates an output side electrical angle θ2 (second electrical angle) representing the rotational (angular) position of output shaft 9, in accordance with the output side sine wave signal sinθ2 and output side cosine wave signal cosθ2. The torque calculating section 19 calculates the steering torque T acting on torsion bar 10, from the electrical angles θ1 and θ2. The neutral correcting section 20 corrects the steering torque T in accordance with the difference between the electrical angles θ1 and θ2 in the free state of torsion bar 10. The low-pass filter 21 removes or attenuates frequency components higher than or equal to a predetermined cutoff frequency F in the corrected steering torque T. In this example, the cutoff frequency F of low-pass filter 21 is set equal to 100 Hz.

Input side angle calculating section 17 calculates the input side electrical angle θ1 representing the rotational position of input shaft 8, by obtaining an arctangent from input side sine wave signal sinθ1 and input side cosine wave signal cosθ1, and delivers the calculated input side electrical signal θ1 as an input side sensor signal, to the torque calculating section 19. Output side angle calculating section 18 calculates the output side electrical angle θ2 representing the rotational position of output shaft 9, by obtaining an arctangent from output side sine wave signal sinθ2 and output side cosine wave signal cosθ2, and delivers the calculated output side electrical signal θ2 as an output side sensor signal, to the torque calculating section 19.

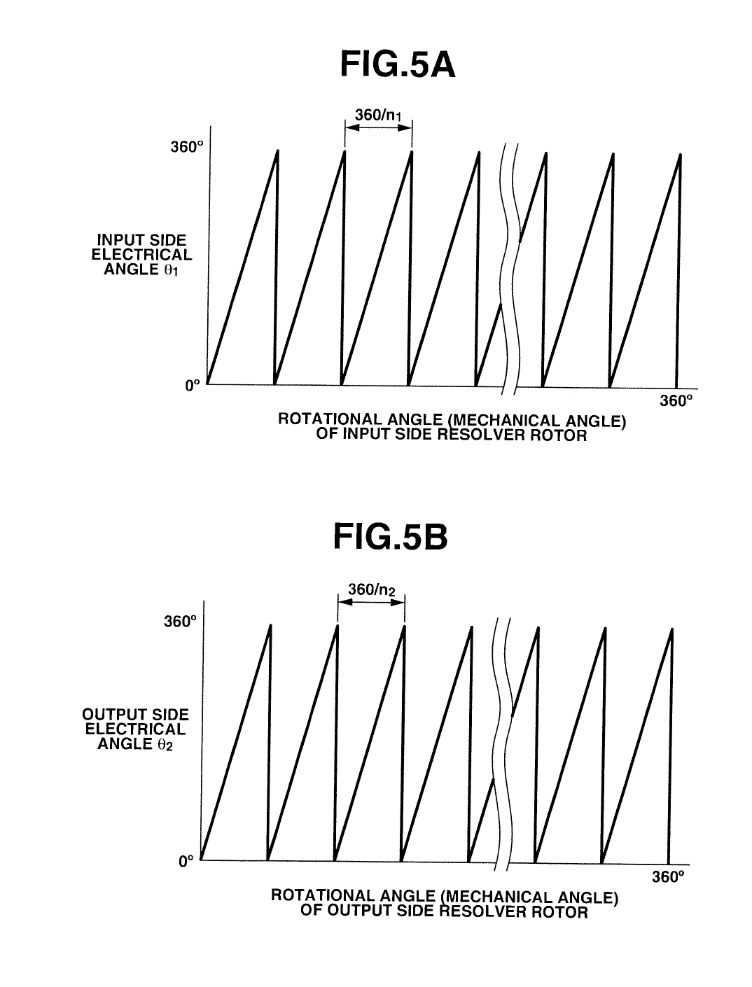

FIGS. 5A and 5B show, respectively, the relationship between the rotational position of input side resolver rotor 12a and the input side electrical angle θ1, and the relationship between the rotational position of output side resolver rotor 13a and the output side electrical angle θ2. In FIGS. 5A and 5B, the position of 0° in the horizontal axis means the condition in which torsion bar 10 is in the free state and the steerable wheels W1 and W2 are directed in the straight ahead direction.

In an illustrated example shown in FIGS. 5A and 5B, the input side electrical angle θ1 and output side electrical angle θ2 are equal to each other in the free state of torsion bar 10. Input side electrical angle θ1 varies periodically and io repeats its values each time the input side resolver rotor 12a rotates through an angle (360/n1)°. Similarly, the output side electrical angle θ2 varies periodically and repeats its values each time the output side resolver rotor 13a rotates through an angle (360/n2)°.

The input side resolver 12 is configured to satisfy a relationship given by a following mathematical expression (1), and the output side resolver 13 is configured to satisfy a relationship given by a following mathematical expression (2). In these mathematical expressions (1) and (2), B is the bit length of the microcomputer constituting the torque sensing ECU 15.

36000/2B≦n1<360/A (1)

36000/2B≦n2<360/A (2)

Thus, in the example of this embodiment, the relative rotational angle range A between the shafts 8 and 9 is equal to 12 degrees, and the bit length B of the microcomputer of torque sensing ECU 15 is equal to 12 bits. Therefore, the resolvers 12 and 13 are arranged so that each of the shaft angle multipliers n1 and n2 is greater than or equal to 9, and smaller than 30 (9≦n1<30, and 9≦n2<30). In the example shown in FIG. 3, the resolvers 12 and 13 are so configured that each of the shaft angle multipliers n1 and n2 is equal to 25 (n1=25 and n2=25). Thus, in the example shown in FIG. 3, the number of projections 14 is equal to 25.

The condition of 36000/2B≦n1 in mathematical expression (1) and the condition of 36000/2^{B}≦n2 in mathematical expression (2) are conditions to make the resolution or resolving power (360/n1)/2^{B} of the input side resolver 12 for sensing the rotational position, and the io resolution or resolving power (360/n2)/2^{B} of the output side resolver 13 for sensing the rotational position, smaller than or equal to 0.01°/digit ((360/n1)/2^{B≦}0.01°/digit and (360/n2)/2^{B}≦0.01° /digit) to obtain a smooth steering feeling. In order to make the steering feeling smoother, it is preferable to make the resolutions in the microcomputer, of resolvers 12 and 13 for sensing the rotational position, smaller than or equal to 0.006° /digit by substituting 60000/2^{B} for 36000/2B in mathematical expressions (1) and (2) (60000/2^{B}≦n1<360/A and 60000/2^{B}≦n2<360/A).

The condition of n1<360/A in mathematical expression (1) is a condition for making the period one cycle (360/n1) of first electrical angle θ1, greater than the relative rotational angle range A between input and output shafts 8 and 9. The condition of n2<360/A in mathematical expression (2) is a condition for making the period of one cycle (360/n2) of second electrical angle θ2 greater than the relative rotational angle range A between input and output shafts 8 and 9. Therefore, in the system including resolvers 12 and 13 constructed to meet the relationships expressed by mathematical expressions (1) and (2), the phase difference between first and second electrical angles θ1 and θ2 does not exceed either of the periods (360/n1, 360/n2) of first and second electrical angles θ1 and θ2 while the relative rotational angle of input shaft 8 relative to output shaft 9 is varied from −A/2° to A/2°, and the difference between first and second electrical angles θ1 and θ2 do not become equal to the same value while the relative rotational angle of input shaft 8 relative to output shaft 9 is varied from −A/2° to A/2. If the phase difference between the mechanical angles obtained from the outputs of first and second resolvers 12 and 13 exceeds the period of one cycle during the process of variation of the relative rotational angle between first and second shafts 8 and 9 within the relative rotational angle range A, there is a possibility of error of calculating a difference by comparing two electrical angles other than correct electrical angles to be compared. By contrast, the system according to this embodiment is so arranged that the phase difference between the mechanical angles obtained from the outputs of the resolvers does not become greater than the period of one cycle. Therefore, the system can improve the torque sensing accuracy.

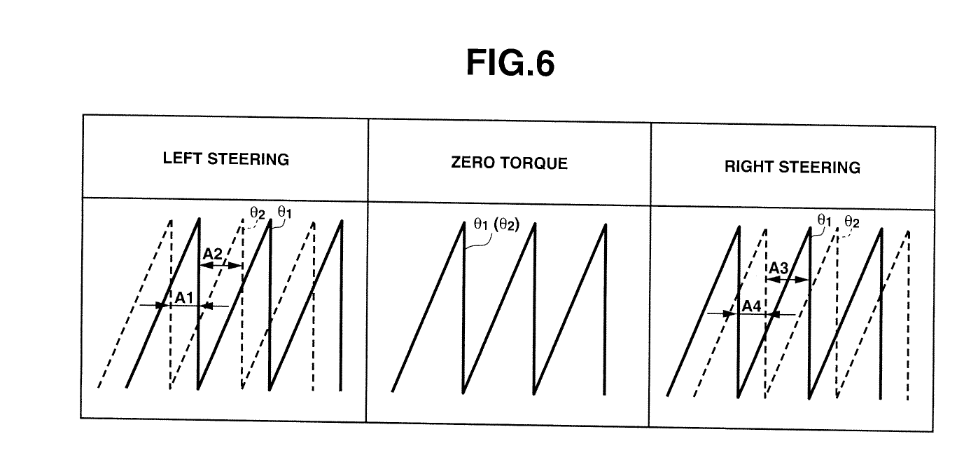

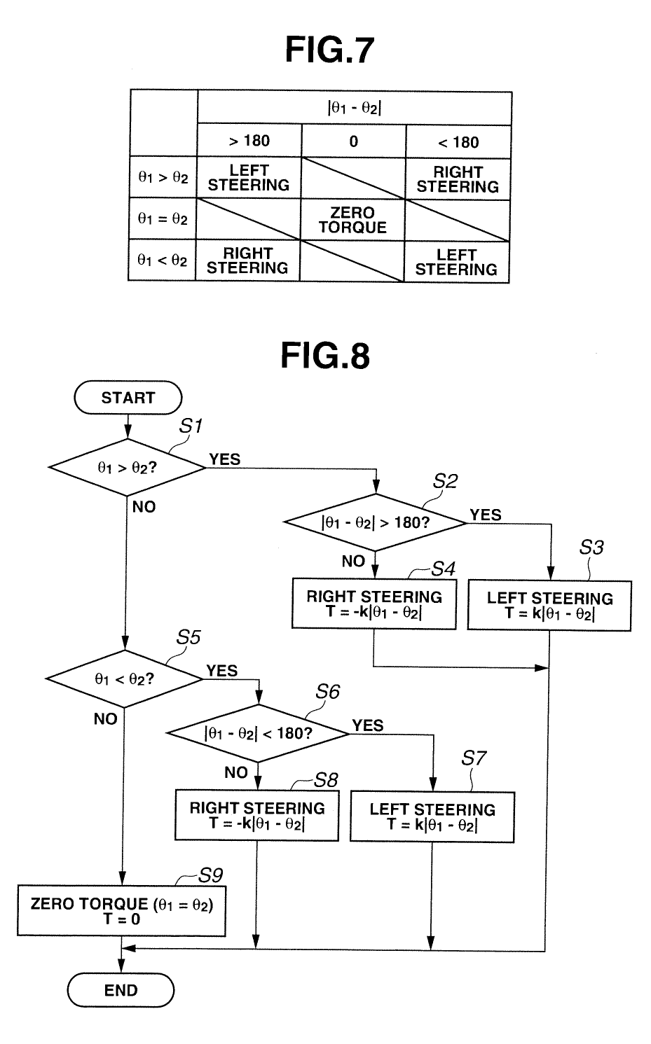

FIG. 6 is a view for illustrating the relationship between first and second electrical angles θ1 and θ2 when the torsion bar 10 is twisted during a steering operation. FIG. 7 is a table showing a relation among first and second electrical angles θ1 and θ2 and the steering direction.

As shown in FIGS. 6 and 7, the input side electrical angle θ1 and the output side electrical angle θ2 are equal to each other (θ1=θ2) in the free state of torsion bar 10 in which the steering torque of the driver to operate the steering wheel SW is equal to zero. When input shaft 8 is rotated in the left steering direction relatively with respect to output shaft 9, the absolute value of the difference between electrical angles θ1 and θ2 is greater than 180 (|θ1−θ2|>180) in a rotational angle region A1 in which first electrical angle θ1 is greater than second electrical angle θ2 (θ1>θ2), and the absolute value of the difference io between electrical angles θ1 and θ2 is smaller than 180 (|θ1−θ2|<180) in a rotational angle region A2 in which first electrical angle θ1 is smaller than second electrical angle θ2 (θ1<θ2). When input shaft 8 is rotated in the right steering direction relatively with respect to output shaft 9, the absolute value of the difference between electrical angles θ1 and θ2 is smaller than 180 (|θ1−θ2|<180) in a rotational angle region A3 in which first electrical angle θ1 is greater than second electrical angle θ2 (θ1>θ2), and the absolute value of the difference between electrical angles θ1 and θ2 is greater than 180 (|θ1−θ2|>180) in a rotational angle region A4 in which first electrical angle θ1 is smaller than second electrical angle θ2 (θ1<θ2).

Torque calculating section 19 shown in FIG. 4 determines the direction of the steering torque acting on torsion bar 10, from first and second electrical angles θ1 and θ2, by using the table shown in FIG. 6, and calculates the magnitude of the steering torque T acting on torsion bar 10, by multiplying the absolute value of the difference between electrical angles θ1 and θ2, representing the amount of torsion, by a spring constant k of the torsion bar 10.

FIG. 8 shows a steering torque calculating process performed by torque calculating section 19, in the form of a flowchart. In the example of FIG. 8, the steering torque is positive in the left steering direction, and negative in the right steering direction.

As shown in FIG. 8, the torque calculating section 19 first determines whether first electrical angle θ1 is greater than second electrical angle θ2 (θ1>θ2?) at a step S1. When θ1>θ2 and hence the answer of S1 is YES, the torque io calculating section 19 proceeds from S1 to a step S2, and determines whether the absolute value of the difference between first and second electrical angles θ1 and θ2 is greater than 180 (101-021>180) at step S2. When 101-021>180 and hence the answer of S2 is YES, the torque calculating section 19 judges the steering torque T to be acting in the left steering direction, and proceeds to a step S3. Torque calculating section 19 calculates steering torque T according to the equation T=k|θ1−θ2| at step S3, and terminates the calculating process of FIG. 8. When |θ1−θ2|<180 and hence the answer of S2 is NO, the torque calculating section 19 judges the steering torque T to be acting in the right steering direction, and proceeds to a step S4. Torque calculating section 19 calculates steering torque T according to the equation T=−k|θ1″θ2| at step S4, and terminates the calculating process of FIG. 8.

When θ1 is not greater than θ2, and the answer of step S1 is NO, the torque calculating section 19 proceeds to a step S5, and examines whether first electrical angle θ1 is smaller than second electrical angle θ2 (θ1<θ2?). When θ1<θ2 and hence the answer of S5 is YES, the torque calculating section 19 proceeds from S5 to a step S6, and determines whether the absolute value of the difference between first and second electrical angles θ1 and θ2 is smaller than 180 (|θ1−θ2|<180) at step S6. When |θ1−θ2|<180 and hence the answer of S6 is YES, the torque calculating section 19 judges the steering torque T to be acting in the left steering direction, and proceeds to a step S7. Torque calculating section 19 calculates steering torque T according to the equation T=k|θ1−θ2| at step S7, and io terminates the calculating process of FIG. 8. When |θ1−θ2|>180 and hence the answer of 56 is NO, the torque calculating section 19 judges the steering torque T to be acting in the right steering direction, and proceeds to a step 58. Torque calculating section 19 calculates steering torque T according to the equation T=−k|θ1−θ2| at step S8, and terminates the calculating process of FIG. 8.

When first electric angle θ1 is not smaller than second electric angle θ2, and hence the answer of step S5 is NO, the torque calculating section 19 judges that first electric angle θ1 is equal to second electric angle θ2 (θ1=θ2), and sets the steering torque T equal to zero (T=0). Then, torque calculating section 19 terminates the process of FIG. 8.

Neutral correcting section 20 shown in FIG. 4 stores a steering torque correction quantity based on a difference between first and second electrical angles θ1 and θ2 in the free state of torsion bar 10, and corrects the steering torque T, by adding the steering torque correction quantity to the steering torque T calculated by torque calculating section 19. Generally, there is a difference between electrical angles θ1 and θ2 obtained by resolvers 12 and 13 even in the free state of torsion bar 10, because of various factors such as assembly errors of resolver rotors 12a and 1 3a to input shaft 8 or output shaft 9 and assembly errors of resolver stators 12b and 13b to housing 11. This difference between electrical angles θ1 and θ2 in the free state of torsion bar 10 may cause error in the steering torque T calculated by torque calculating section 19. Therefore, this error is preliminarily stored as the steering torque correction quantity in neutral correction section 20, and used to correct the steering torque T as mentioned above, to reduce the error of steering torque T.

Low-pass filter 21 receive the corrected steering torque T corrected by neutral correcting section 20, and removes frequency components over the predetermined cutoff frequency F. The thus-processed steering torque T is delivered to steering assist ECU 5 shown in FIG. 1. In this example, the cutoff frequency F of low-pass filter 21 is 100 Hz.

The steering torque T calculated by the microcomputer varies stepwise in accordance with the resolutions in the rotational position detection, of the resolvers 12 and 13 when the steering torque acing on torsion bar 10 is varied. In order to make the stepwise change of steering torque T smoother when the steering wheel SW is turned at a steering speed higher than or equal to 1°/sec, and hence the input and output shafts 8 and 9 rotate relative to each other at a speed higher than or equal to 1°/sec; the cutoff frequency F of low-pass filter 21 is so set as to satisfy both of relationships of following mathematical expressions (3) and (4). In other words, the input side resolver 12 is so configured as to satisfy a relationship of a following mathematical expression (5), and the output side resolver 13 is so configured as to satisfy a relationship of a following mathematical expression (6).

F≦1/(360/n1)/2^{B}) (3)

F≦1/(360/n2)/2^{B}) (4)

360F/2^{B}≦n1 (5)

360F/2^{B}≦n2 (6)

That is, because, in the example of this embodiment, the shaft angle multipliers n1 and n2 of resolvers 12 and 13 are equal to 25, and the bit length of the microcomputer is equal to 12 bits, the cutoff frequency F of low-pass filter 21 is lower than or equal to 284.4 Hz.

Steering assist ECU 5 shown in FIG. 1 produces the drive command signal in accordance with the steering torque T, and delivers the drive command signal to motor drive circuit 6, as mentioned before. In response to the drive command signal, the motor drive circuit 6 supplies electric power to the motor M, and thereby imparts a steering assist force to the rack shaft 3.

Accordingly, the difference between the input side electrical angle θ1 and output side electrical angle θ2 does not become equal to the same value during the process of variation of the relative rotational angle of input shaft 8 relative to output shaft from −A/2° to A/2° because the cycle of each of the electrical angles θ1 and θ2 is greater than the relative rotational angle range A between input and output shafts 8 and 9. Therefore, the torque sensing system according to this embodiment can restrain errors in sensing the steering torque T, and improve the sensing accuracy of steering torque T.

Moreover, the neutral correcting section 20 corrects the steering torque T by using the difference between electrical angles θ1 and θ2 in the free state of torsion bar 10.

Therefore, the torque sensing system according to this embodiment can further improve the sensing accuracy of steering torque T.

Moreover, the torque sensing system is arranged so that the difference between electrical angles θ1 and θ2 is varied in proportion to the steering torque T acting on torsion bar 10 by setting the electrical angles θ1 and θ2 to be approximately equal to each other in the free state of torsion bar 10. Therefore, the torque sensing system can make easier the calculation in torque calculating section 19 of calculating the direction and magnitude of the steering torque T.

The resolution or resolving power of each of resolvers 12 and 13 in the rotation position sensing is smaller than or equal to 0.01°/digit, or smaller than or equal to 0.006°/digit. Therefore, the power steering system can vary the steering assist force with electric motor M smoothly, and thereby improve the steering feeling.

Low-pass filter 21 is used to make smooth stepwise variation of the steering torque T based on the resolutions of resolvers 12 and 13 in the rotational position sensing. Therefore, the power steering system can vary the steering assist force with electric motor M smoothly, and further improve the steering feeling.

In the example shown in FIG. 4, the neutral correcting section 20 is provided between torque calculating section 19 and low-pass filter 21. However, the position of neutral correcting section 20 is not limited to this. It is optional to provide at either or both of a position between the input side angle calculating section 17 and torque calculating section 19 and a position between the output side angle calculating section 18 and torque calculating section 19. In this case, the neutral correcting section 20 corrects at io least one of the electrical angles θ1 and θ2 so as to make the electrical angles θ1 and θ2 equal to each other in the free state of torsion bar 10. The thus-arranged neutral correcting section can provide the same effects as neutral correcting section 20 shown in FIG. 4.

Furthermore, it is possible to provide the neutral correcting section at either or both of a position between the input side resolver 12 and input side angle calculating section 17 and a position between the output side resolver 13 and output side angle calculating section 18. In this case, the neutral correcting section 20 corrects at least one of the input side sine wave signal sinθ1 and output side sine wave signal sinθ2 and at least one of the input side cosine wave signal cosθ1 and output side cosine wave signal cosθ2 so as to make the input side sine wave signal sinθ1 and input side cosine wave signal cosθ1, respectively, equal to the output side sine wave signal sinθ2 and output side cosine wave signal cosθ2 in the free state of torsion bar 10. The thus-arranged neutral correcting section can provide the same effects as neutral correcting section 20 shown in FIG. 4.

In the illustrated example of the embodiment, the low-pass filter 21 is arranged to act on the steering torque T calculated by torque calculating section 19. However, it is possible to arrange the low-pass filter to act on both of electrical angles θ1 and θ2. In this case, too, the system can provide the same effects as in the illustrated example.

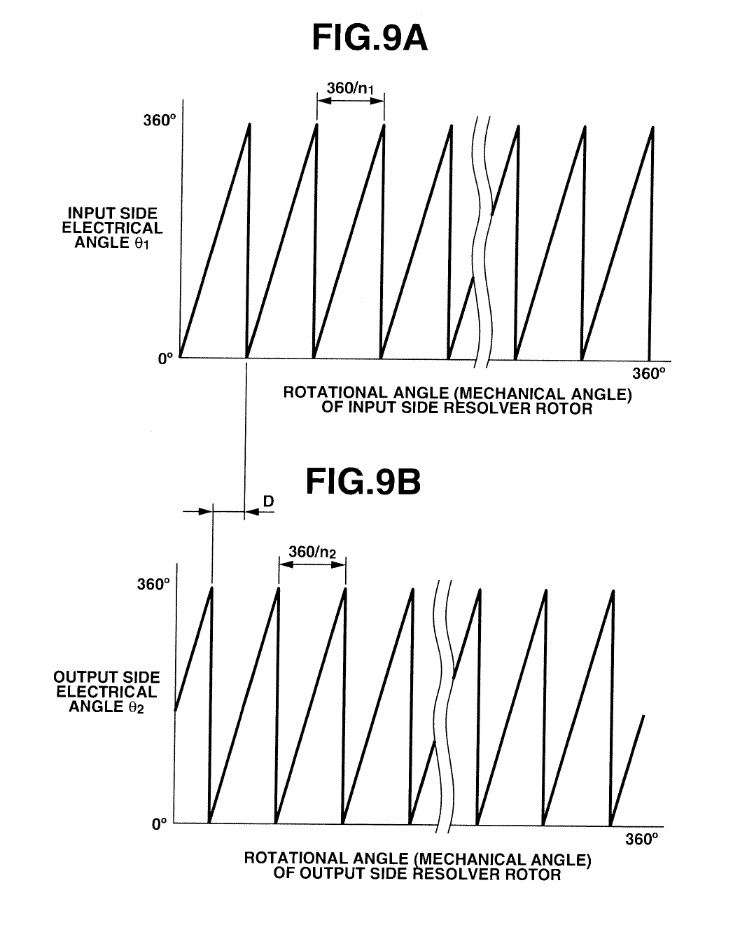

In the illustrated example, the resolvers 12 and 13 are so arranged that the electrical angles θ1 and θ2 become equal to each other in the free state of torsion bar 10. However, it is optional to arrange the resolvers 12 and 13 so that the electrical angles θ1 and θ2 are unequal to each other in the free state of torsion bar 10, as in an variation example shown in FIGS. 9A and 9B. In FIGS. 9A and 9B, the position of 0° in the horizontal axis represents the state in which the torsion bar 10 is in the free state, and the steerable wheels W1 and W2 are in the straight ahead position.

In the variation example shown in FIGS. 9A and 9B, the resolvers 12 and 13 are configured so that the phases of electrical angles θ1 and θ2 are shifted from each other by an amount of a mechanical angle D°, and the resolvers 12 and 13 are so configured as to satisfy relationships of following mathematical expressions (7) and (8). In the other respects, the variation example of FIGS. 9A and 9B is identical to the illustrated example of the embodiment.

36000/2^{B}≦n1<360/(A+D) (7)

36000/2^{B}≦n2<360/(A+D) (8)

Therefore, in this variation example as in the illustrated example of the embodiment, the phase difference between the electrical angles θ1 and θ2 does not exceed the period of each of electrical angles θ1 and θ2 while the relative rotational angle of input shaft 8 relative to output shaft 9 varies from −A/2° to A/2°, and the difference between the electrical angles θ1 and θ2 does not become equal to the same value during the process of variation of the relative rotational angle of input shaft 8 relative to output shaft from −A/2° to A/2°. Thus, the variation example can provide effects similar to those of the illustrated example of the embodiment.

Moreover, even if there arises an error in the phase difference D between electrical angles θ1 and θ2 in the free state of torsion bar 10, the system can prevent reversal of the magnitudes of electrical angles θ1 and θ2. Therefore, the system can determine the direction of steering torque T more accurately even in a small range of steering torque T, and thereby improve the sensing accuracy of the steering torque T.

According to one of possible interpretations of embodiments of the present invention, an apparatus (such as a torque sensing apparatus or a power steering apparatus) comprises a torque sensor having a basic construction which may comprise: a rotation shaft including a first shaft and a second shaft which are connected with each other through a torsion bar and which are arranged to be rotatable relative to each other within a relative rotational angle range (A) in which a relative angle between the first shaft and the second shaft due to torsion (or torsional deformation) of the torsion bar is limited to a maximum angle A; a first resolver which is arranged to produce a first resolver output signal (such as a first sine wave signal and a first cosine wave signal) in accordance with a rotational angular position of the first shaft, and to have a shaft angle multiplier n1 (or multiplication factor of angle) satisfying a relationship of n1<360/A; a second resolver which is arranged to produce a second resolver output signal (such as a second sine wave signal and a second cosine wave signal) in accordance with a rotational angular position of the second shaft, and to have a shaft angle multiplier n2 (or multiplication factor of angle) satisfying a relationship of n2<360/A; and a controlling section (15, 5) io to calculate a torque acting on the torsion bar (with a microcomputer). Thus, in the process of variation of the relative rotational angle between the first and second shafts in the relative rotational angle range (A), the difference between both electrical angles obtained from the is first and second resolver output signals varies without assuming the same value.

Alternatively, the basic structure of the torque sensor may comprise: a rotation shaft including a first shaft and a second shaft which are connected with each other through a torsion bar and which are arranged to be rotatable relative to each other within a relative rotational angle range in which a relative angle between the first shaft and the second shaft due to torsion (or torsional deformation) of the torsion bar is limited to a maximum angle A; a first resolver including a first resolver rotor arranged to rotate with the first shaft and a first resolver stator arranged to produce a first sine wave signal and a first cosine wave signal at a number of cycles per revolution X1 (or angular frequency) within a range in which the number of cycles per revolution of the first resolver rotor is smaller than 360/A (X1<360/A); a second resolver including a second resolver rotor arranged to rotate with the second shaft and a second resolver stator arranged to produce a second sine wave signal and a second cosine wave signal at a number of cycles per revolution X2 (or angular frequency) within a range in which the number of cycles per revolution of the second resolver rotor is smaller than 360/A (X2<360/A); and a controlling section (including at least a control unit) which includes a calculation section (17, 18, 19) to calculate a first rotational angle representing a rotational angle of the first shaft in accordance with the first sine wave signal and the first cosine wave signal, to calculate a second rotational angle representing a rotational angle of the second shaft in accordance with the second sine wave signal and the second cosine wave signal, and to calculate a torque produced between the first and second shafts, in accordance with a phase difference between the first rotational angle and the second rotational angle with a microcomputer. Thus, the phase difference between the first resolver output signal and the second resolver output signal during torsion of the torsion bar does not exceed the period of one cycle. Consequently, the torque sensor can restrain error in sensing the torque.

The apparatus (such as a torque sensing apparatus or a power steering apparatus) may further comprise any one or more of the following features (T1)-(T12) in addition to the above-mentioned basic structure of the torque sensor.

(T1) The controlling section (or control unit) includes a microcomputer having a bit length B for calculating the torque; the first resolver stator is arranged to produce the first sine wave signal and the first cosine wave signal at the number X1 (or n1) of cycles per revolution of the first resolver rotor so that X1≧36000/2^{B}; and the second resolver stator is arranged to produce the second sine wave signal and the second cosine wave signal at the number X2 (or n2) of cycles per revolution of the second resolver rotor so that X2≧36000/2^{B}. Thus, it is possible to make the resolution or resolving power of the torque in the io microcomputer (or the resolution of each of the resolvers), smaller than or equal to 0.01 deg/digit, and to perform a smooth motor control.

(T2) The first resolver stator is arranged to produce the first sine wave signal and the first cosine wave signal at the number X1 (n1) of cycles per revolution of the first resolver rotor within a range in which the number X1 of cycles per revolution of the first resolver rotor is greater than or equal to 60000/2^{B} (X1≧60000/2^{B}); and the second resolver stator is arranged to produce the second sine wave signal and the second cosine wave signal at the number X2 (n2) of cycles per revolution of the second resolver rotor within a range in which the number X2 of cycles per revolution of the second resolver rotor is greater than or equal to 60000/2^{B} (X2≧60000/2^{B}). Thus, it is possible to make the resolution or resolving power of the torque in the microcomputer (or the resolution of each of the resolvers), smaller than or equal to 0.006 deg/digit, and to perform a smooth motor control.

(T3) The controlling section or control unit includes a low-pass filter to remove components with frequencies higher than a predetermined cutoff frequency F Hz from a signal representing the torque produced by the calculation section; the first resolver stator is arranged to produce the first sine wave signal and the first cosine wave signal at the number X1 (n1) of cycles per revolution of the first resolver rotor within a range in which the number X1 of cycles per revolution of the first resolver rotor is greater than or equal to 360×F/2⁸ (X1≧360×F/2^{B}); and the second resolver stator is arranged to produce the second sine wave signal and the second cosine wave signal at the number X2 (n2) of cycles per revolution of the second resolver rotor within a range in which the number X2 of cycles per revolution of the second resolver rotor is greater than or equal to 360×F/2^{B}≧360×F/2^{B}). Because the cutoff frequency of the low-pass filter is lower than the torque resolving power in the microcomputer, the apparatus can perform a smooth motor control by smoothing a step feeling in the motor control with the low-pass filter.

(T4) The first resolver is arranged to produce the first sine wave signal which is in phase with the second sine wave signal in a free state of the torsion bar free of torque, and the second resolver stator is arranged to produce the second cosine wave signal which is in phase with the first cosine wave signal in the free state of the torsion bar. Therefore, the apparatus can make the phase difference between the first and second rotational angles greater with respect to change in the actual torque, and improve the torque sensing accuracy.

(T5) The controlling section or the microcomputer of the control unit is configured to modify at least one of the first sine wave signal and the second sine wave signal so that the first sine wave signal and the second sine wave signal are in phase with each other in the free state of the torsion bar free of torque, and to modify at least one of the first cosine wave signal and the second cosine wave signal so that the first cosine wave signal and the second cosine wave signal are in phase with each other in the free state of the torsion bar. With this modification in the controlling section or in the microcomputer, it is possible to simplify the io control circuit.

(T6) The first and second resolvers are arranged to produce the first sine wave signal which is shifted in phase by a predetermined amount (or phase difference) D, from the second sine wave signal and to produce the second cosine wave signal which is shifted in phase by the amount D from the first cosine wave signal in the free state of the torsion bar. Therefore, the apparatus can make the phase difference between the first and second rotational angles greater with respect to change in the actual torque, and improve the torque sensing accuracy.

(T7) The first resolver stator is arranged to produce the first sine wave signal and the first cosine wave signal at the number X1 of cycles per revolution of the first resolver rotor within a range in which the number X1 of cycles per revolution of the first resolver rotor is smaller than 360/(A+D) (X1<360/(A+D)); and the second resolver stator is arranged to produce the second sine wave signal and the second cosine wave signal at the number X2 of cycles per revolution of the second resolver rotor within a range in which the number X2 of cycles per revolution of the second resolver rotor is smaller than 360/(A+D) (X2<360/(A+D)). Therefore, the apparatus can prevent the phase difference between the first resolver output signal and the second resolver output signal due to torsion of the torsion bar from exceeding the period of one cycle even if the phase difference in the neutral or free state is included.

(T8) The controlling section or the microcomputer judges that the first shaft is twisted in a first twisting io direction (left, for example) relative to the second shaft when the first rotational angle is greater than the second rotational angle and an absolute value of a difference between the first rotational angle and the second rotational angle is greater than 180 degrees, and when the first rotational angle is smaller than the second rotational angle and the absolute value of the difference between the first rotational angle and the second rotational angle is smaller than 180 degrees, and the microcomputer judges that the first shaft is twisted in a second twisting direction (right, for example) opposite to the first twisting direction, relative to the second shaft when the first rotational angle is greater than the second rotational angle and the absolute value of the difference between the first rotational angle and the second rotational angle is smaller than 180 degrees, and when the first rotational angle is smaller than the second rotational angle and the absolute value of the difference between the first rotational angle and the second rotational angle is greater than 180 degrees. Therefore, the apparatus can detect the direction of the torque accurately.

(T9) At least one of the first and second resolvers is arranged so that the first electrical angle calculated from the first resolver output signal and the second electrical angle calculated from the second resolver output signal become equal to each other in the free or neutral state of the torsion bar. In this case, the difference between the first and second electrical angles is varied in proportion to the torque acting on the torsion bar. Therefore, it is possible to simplify the calculation of the torque.

(T10) The controlling section or the microcomputer is configured to modify at least one of the first resolver output signal, the second resolver output signal and the calculated torque in accordance with the phase shift (D) between the first and second resolver output signals in the free state of the torsion bar. Therefore, the apparatus can further improve the torque sensing accuracy.

(T11) At least one of the first and second resolvers is arranged so that the first electrical angle calculated from the first resolver output signal and the second electrical angle calculated from the second resolver output signal become unequal to each other in the free or neutral state of the torsion bar. In this case, it is possible to make the difference between the first and second electrical angles greater in a smaller torque region in which the quantity of torsion of the torsion bar is relatively small, and to improve the torque sensing accuracy.

(T12) The phase difference between the first and second electrical angles in the free state of the torsion bar is D°; the first resolver is arranged to satisfy a relationship of n1<360/(A+D); and the second resolver is arranged to satisfy a relationship of n2<360/(A+D). Therefore, the apparatus can prevent the phase difference between the first resolver output signal and the second resolver output signal due to torsion of the torsion bar from exceeding the period of one cycle of each electrical angle, and thereby improve the torque sensing accuracy.

This application is based on a prior Japanese Patent Application No. 2011-091153 filed on Apr. 15,2011. The entire contents of this Japanese Patent Application are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A torque sensor comprising:
a rotation shaft including a first shaft and a second shaft which are connected with each other through a torsion bar and which are arranged to rotate relative to each other within a relative rotational angle range in which a relative angle between the first shaft and the second shaft due to torsion of the torsion bar is limited to a maximum angle A;
a first resolver including a first resolver rotor io arranged to rotate with the first shaft and a first resolver ii stator arranged to produce a first sine wave signal and a first cosine wave signal at a number of cycles per revolution X1 within a range in which the number of cycles per revolution of the first resolver rotor is smaller than 360/A (X1<360/A);
a second resolver including a second resolver rotor arranged to rotate with the second shaft and a second resolver stator arranged to produce a second sine wave signal and a second cosine wave signal at a number of cycles per revolution X2 within a range in which the number of cycles per revolution of the second resolver rotor is smaller than 360/A (X2<360/A); and
a control unit which includes a microcomputer and which includes a calculation section to calculate a first rotational angle representing a rotational angle of the first shaft in accordance with the first sine wave signal and the first cosine wave signal, to calculate a second rotational angle representing a rotational angle of the second shaft in accordance with the second sine wave signal and the second cosine wave signal, and to calculate a torque produced between the first and second shafts, in accordance with a phase difference between the first rotational angle and the second rotational angle.

2. The torque sensor as claimed in claim 1, wherein the microcomputer of the control unit has a bit length B; the first resolver stator is arranged to produce the first sine wave signal and the first cosine wave signal at the number X1 of cycles per revolution of the first resolver rotor within a range in which the number X1 of cycles per revolution of the first resolver rotor is greater than or equal to 36000/2^{B} (X1≧36000/2^{B}); and the second resolver stator is arranged to produce the second sine wave signal and the second io cosine wave signal at the number X2 of cycles per revolution of the second resolver rotor within a range in which the number X2 of cycles per revolution of the second resolver rotor is greater than or equal to 36000/2^{B} (X2≧36000/2^{B}).

3. The torque sensor as claimed in claim 2, wherein the first resolver stator is arranged to produce the first sine wave signal and the first cosine wave signal at the number X1 of cycles per revolution of the first resolver rotor within a range in which the number X1 of cycles per revolution of the first resolver rotor is greater than or equal to 60000/2^{B} (X1≧60000/2^{B}); and the second resolver stator is arranged to produce the second sine wave signal and the second cosine wave signal at the number X2 of cycles per io revolution of the second resolver rotor within a range in ii which the number X2 of cycles per revolution of the second resolver rotor is greater than or equal to 60000/2^{B} (X2≧60000/2^{B}).

4. The torque sensor as claimed in claim 3, wherein the control unit includes a low-pass filter to remove components with frequencies higher than a predetermined cutoff frequency F Hz from a signal representing the torque produced by the calculation section; the first resolver stator is arranged to produce the first sine wave signal and the first cosine wave signal at the number X1 of cycles per revolution of the first resolver rotor within a range in which the number X1 of cycles per revolution of the first resolver rotor is greater than or equal to 360×F/2^{B} (X1≧360×F/2^{B}); and the second resolver stator is arranged to produce the second sine wave signal and the second cosine wave signal at the number X2 of cycles per revolution of the second resolver rotor within a range in which the number X2 of cycles per revolution of the second resolver rotor is greater than or equal to 360×F/2^{B} (X2≧360×F/2^{B}).

5. The torque sensor as claimed in claim 1, wherein the first resolver is arranged to produce the first sine wave signal which is in phase with the second sine wave signal when a quantity of torsion of the torsion bar is zero, and the second resolver stator is arranged to produce the second cosine wave signal which is in phase with the first cosine wave signal when the quantity of torsion of the torsion bar is zero.

6. The torque sensor as claimed in claim 5, wherein the microcomputer of the control unit is configured to modify at least one of the first sine wave signal and the second sine wave signal so that the first sine wave signal and the second sine wave signal are in phase with each other when the quantity of torsion of the torsion bar is zero, and to modify at least one of the first cosine wave signal and the second cosine wave signal so that the first cosine wave signal and the second cosine wave signal are in phase with each other when the quantity of torsion of the torsion bar is zero.

7. The torque sensor as claimed in claim 1, wherein the first resolver is arranged to produce the first sine wave signal which is shifted in phase by a predetermined amount D, from the second sine wave signal when a quantity of torsion of the torsion bar is zero and the second resolver is arranged to produce the second cosine wave signal which is shifted in phase by the amount D from the first cosine wave signal when the quantity of torsion of the torsion bar is zero.

8. The torque sensor as claimed in claim 7, wherein the first resolver stator is arranged to produce the first sine wave signal and the first cosine wave signal at the number X1 of cycles per revolution of the first resolver rotor within a range in which the number X1 of cycles per revolution of the first resolver rotor is smaller than 360/(A+D) (X1<360/(A+D)); and the second resolver stator is arranged to produce the second sine wave signal and the second cosine wave signal at the number X2 of cycles per io revolution of the second resolver rotorwithin a range in which the number X2 of cycles per revolution of the second resolver rotor is smaller than 360/(A+D) (X2<360/(A+D)).

9. The torque sensor as claimed in claim 1, wherein the microcomputer of the control unit judges that the first shaft is twisted in a first twisting direction relative to the second shaft when the first rotational angle is greater than the second rotational angle and an absolute value of a difference between the first rotational angle and the second rotational angle is greater than 180 degrees, and when the first rotational angle is smaller than the second rotational angle and the absolute value of the difference between the first rotational angle and the second rotational angle is smaller than 180 degrees, and the microcomputer judges that the first shaft is twisted in a second twisting direction opposite to the first twisting direction, relative to the second shaft when the first rotational angle is greater than the second rotational angle and the absolute value of the difference between the first rotational angle and the second rotational angle is smaller than 180 degrees, and when the first rotational angle is smaller than the second rotational angle and the absolute value of the difference between the first rotational angle and the second rotational angle is greater than 180 degrees.

10. A power steering apparatus comprising:
a rotation shaft including a first shaft connected with a steering wheel and a second shaft which is connected with a steerable wheel, and which is further connected with the first shaft through a torsion bar, the first and second shafts being arranged to be rotatable relative to each other within a relative rotational angle range in which a relative angle between the first shaft and the second shaft due to torsion of the torsion bar is limited to a maximum angle A;
a first resolver including a first resolver rotor arranged to rotate with the first shaft and a first resolver stator arranged to produce a first sine wave signal and a first cosine wave signal at a number of cycles per revolution X1 within a range in which the number of cycles per revolution of the first resolver rotor is smaller than 360/A (X1<360/A);
a second resolver including a second resolver rotor arranged to rotate with the second shaft and a second resolver stator arranged to produce a second sine wave signal and a second cosine wave signal at a number of cycles per revolution X2 within a range in which the number of cycles per revolution of the second resolver rotor is smaller than 360/A (X2<360/A);
a control unit which includes a microcomputer and which includes a calculation section to calculate a first rotational angle representing a rotational angle of the first shaft in accordance with the first sine wave signal and the first cosine wave signal, to calculate a second rotational angle representing a rotational angle of the second shaft in accordance with the second sine wave signal and the second cosine wave signal, and to calculate a torque produced between the first and second shafts, in accordance with a phase difference between the first rotationl angle and the second rotational angle; and
an electric motor arranged to be controlled in accordance with the torque, and to provide a steering assist force to the steerable wheel.

11. The power steering apparatus as claimed in claim 10, wherein the microcomputer of the control unit has a bit length B; the first resolver stator is arranged to produce the first sine wave signal and the first cosine wave signal at the number X1 of cycles per revolution of the first resolver rotor within a range in which the number X1 of cycles per revolution of the first resolver rotor is greater than or equal to 36000/2^{B} (X1≧36000/2^{B}); and the second resolver stator is arranged to produce the second sine wave signal and the second cosine wave signal at the number X2 of cycles per revolution of the second resolver rotor within a range in which the number X2 of cycles per revolution of the second resolver rotor is greater than or equal to 36000/2⁸ (X2≧36000/2^{B}).

12. The power steering apparatus as claimed in claim 11, wherein the first resolver stator is arranged to produce the first sine wave signal and the first cosine wave signal at the number X1 of cycles per revolution of the first resolver rotor within a range in which the number X1 of cycles per revolution of the first resolver rotor is greater than or equal to 60000/2^{B} (X1≧60000/2^{B}); and the second resolver stator is arranged to produce the second sine wave signal and the second cosine wave signal at the number X2 of cycles per revolution of the second resolver rotor within a range in which the number X2 of cycles per revolution of the second resolver rotor is greater than or equal to 60000/2^{B} (X2≧60000/2^{B}).

13. The power steering apparatus as claimed in claim 12, wherein the control unit includes a low-pass filter to remove components with frequencies higher than a predetermined cutoff frequency F Hz from a signal representing the torque produced by the calculation section; the first resolver stator is arranged to produce the first sine wave signal and the first cosine wave signal at the number X1 of cycles per revolution of the first resolver rotor within a range in which the number X1 of cycles per revolution of the first resolver rotor is greater than or equal to 360×F/2^{B} (X1≧360×F/2^{B}); and the second resolver stator is arranged to produce the second sine wave signal and the second cosine wave signal at the number X2 of cycles per revolution of the second resolver rotorwithin a range in which the number X2 of cycles per revolution of the second resolver rotor is greater than or equal to 360×F/2^{B} (X2≧360×F/2^{B}).

14. The power steering apparatus as claimed in claim 10, wherein the first resolver is arranged to produce the first sine wave signal which is in phase with the second sine wave signal when a quantity of torsion of the torsion bar is zero, and the second resolver is arranged to produce the second cosine wave signal which is in phase with the first cosine wave signal when the quantity of torsion of the torsion bar is zero.

15. The power steering apparatus as claimed in claim 10, wherein the first resolver is arranged to produce the first sine wave signal which is shifted in phase by a predetermined amount D, from the second sine wave signal when a quantity of torsion of the torsion bar is zero, and the second resolver is arranged to produce the second cosine wave signal which is shifted in phase by the amount D from the first cosine wave signal when the quantity of torsion of the torsion bar is zero.

16. The power steering apparatus as claimed in claim 10, wherein the microcomputer of the control unit judges that the first shaft is twisted in a first twisting direction relative to the second shaft when the first rotational angle is greater than the second rotational angle and an absolute value of a difference between the first rotational angle and the second rotational angle is greater than 180 degrees, and when the first rotational angle is smaller than the second rotational angle and the absolute value of the io difference between the first rotational angle and the second rotational angle is smaller than 180 degrees 180°, and the microcomputer judges that the first shaft is twisted in a second twisting direction opposite to the first twisting direction, relative to the second shaft when the first rotational angle is greater than the second rotational angle and the absolute value of the difference between the first rotational angle and the second rotational angle is smaller than 180 degrees, and when the first rotational angle is smaller than the second rotational angle and the absolute value of the difference between the first rotational angle and the second rotational angle is greater than 180 degrees.

17. A power steering apparatus comprising:
a rotation shaft including a first shaft connected with a steering wheel and a second shaft which is connected with a steerable wheel, and which is further connected with the first shaft through a torsion bar;
a torque sensing device provided in the rotation shaft;
an electric motor to provide a steering assist force to the steerable wheel;
a controller which includes a microcomputer having a bit length B and which includes a calculation section to calculate a torque produced between the first and second shafts, in accordance with a sensor signal produced by the torque sensing device, a switching circuit to control power supply to the electric motor in accordance with the torque, and a low-pass filter provided between the torque sensing element and the switching circuit, to remove components with frequencies higher than a predetermined cutoff frequency F Hz;
wherein the torque sensing device includes,
a first resolver including a first resolver rotor rotating with the first shaft, and a first resolver stator to produce a first sine wave signal and a first cosine wave signal at a number X1 of cycles per revolution of the first resolver rotor within a range in which the number X1 of cycles per revolution of the first resolver rotor is greater than or equal to 360×F/2^{B} (X1≧360×F/2^{B}), and a second resolver including a second resolver rotor rotating with the second shaft, and a second resolver stator to produce a second sine wave signal and a second cosine wave signal at a number X2 of cycles per revolution of the second resolver rotor within a range in which the number X2 of cycles per revolution of the second resolver rotor is greater than or equal to 360×F/2^{B} (X2≧360×F/2^{B}); and
wherein the calculation section is configured to calculate a first rotational angle representing a rotational angle of the first shaft in accordance with the first sine wave signal and the first cosine wave signal, to calculate a second rotational angle representing a rotational angle of the second shaft in accordance with the second sine wave signal and the second cosine wave signal, and to calculate the torque in accordance with a phase difference between the first rotational angle and the second rotational angle.

18. The power steering apparatus as claimed in claim 17, wherein the rotation shaft is arranged so that a relative angle between the first shaft and the second shaft is limited to a maximum angle A; the first resolver stator is arranged to produce the first sine wave signal and the first cosine wave signal at the number of cycles per revolution X1 within a range in which the number of cycles per revolution of the first resolver rotor is smaller than 360/A (X1<360/A); and the second resolver stator is arranged to produce the second sine wave signal and the second cosine wave signal at the number of cycles per revolution X2 within a range in which the number of cycles per revolution of the second resolver rotor is smaller than 360/A (X2<360/A).

19. The power steering apparatus as claimed in claim 17, wherein the first resolver is arranged to produce the first sine wave signal which is in phase with the second sine wave signal when a quantity of torsion of the torsion bar is zero, and the second resolver is arranged to produce the second cosine wave signal which is in phase with the first cosine wave signal when the quantity of torsion of the torsion bar is zero.

20. The power steering apparatus as claimed in claim 17, wherein the microcomputer of the control unit judges that the first shaft is twisted in a first twisting direction relative to the second shaft when the first rotational angle is greater than the second rotational angle and an absolute value of a difference between the first rotational angle and the second rotational angle is greater than 180 degrees, and when the first rotational angle is smaller than the second rotational angle and the absolute value of the difference between the first rotational angle and the second rotational angle is smaller than 180 degrees 180°, and the microcomputer judges that the first shaft is twisted in a second twisting direction opposite to the first twisting direction, relative to the second shaft when the first rotational angle is greater than the second rotational angle and the absolute value of the difference between the first rotational angle and the second rotational angle is smaller than 180 degrees, and when the first rotational angle is smaller than the second rotational angle and the absolute value of the difference between the first rotational angle and the second rotational angle is greater than 180 degrees.
